(19) United States
(12) Patent Application Publication
(10) Pub. No.: US 2005/0195487 A1
(43) Pub. Date: Sep. 8, 2005

(54) Backlight module with diffusion sheet having a subwavelength grating

(75) Inventors: Tai-Cherng Yu, Tu-Cheng (TW); Charles Leu, Fremont, CA (US); Ga-Lane Chen, Fremont, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/044,838

(22) Filed: Jan. 27, 2005

(30) Foreign Application Priority Data
Mar. 2, 2004 (TW) 93105377

(51) Int. Cl. G02B 13/20

(52) U.S. Cl. 359/599; 359/707

(57) ABSTRACT

A diffusion sheet (23) of the present invention includes a light incident surface (231) having a subwavelength grating (233) formed thereat, and a light emitting surface (232) opposite to the light incident surface. When light beams propagate through the subwavelength grating, they are diffracted forward and backward, to form front diffraction waves and back diffraction waves. Because the subwavelength grating is a zeroth-order grating, it only propagates the zeroth-order diffraction waves. Therefore, based on diffraction theory, the back diffraction waves can be eliminated by adjusting the period T and the shape of the subwavelength grating. If this is done, almost all the incident light beams are transmitted through the incident surface. Thereby, the efficiency of light utilization is enhanced. Moreover, the light beams are diffracted and distributed uniformly. Accordingly, the diffusion sheet yields high uniformity of outgoing light emitted from the emitting surface.

### BACKGROUND OF THE INVENTION

1. Field of the Invention

The present invention relates to a diffusion sheet having a subwavelength grating for controlling light transmission, and to a direct type backlight module for liquid crystal display devices employing such a diffusion sheet.

2. Description of the Prior Art

A typical LCD device comprises an LCD panel, and a backlight module mounted under the LCD panel for supplying light beams thereto. There are two types of backlight modules: the edge type and the direct type. The edge type backlight module mainly comprises a light guide plate, and a light source disposed adjacent to a thin side of the light guide plate. The light guide plate is used for guiding the light beams emitted by the light source to uniformly illuminate the LCD panel.

In contrast, the direct type backlight module employs light sources placed in an air-filled cavity under the LCD panel, and a diffuser disposed between the LCD panel and the light sources.

Referring to FIG. 7, a conventional direct type backlight module 1 includes an optical film 10, a diffusion sheet 12, a reflector 14, and a plurality of tubes 16. The tubes 16 are disposed below the diffusion sheet 12, and are arranged in a predetermined interval. In operation, many of the light beams emitted by the tubes 16 are directly emitted to the diffusion sheet 12, and substantially the entire remainder of the light beams emitted from the tubes 16 are reflected to the diffusion sheet 12 by the reflector 14. Some of the light beams are reflected by an incident surface of the diffusion sheet 12, and then are reflected to the diffusion sheet 12 by the reflector 14.

However, repetitious reflection makes the backlight module 1 yield a low uniformity of outgoing light. Moreover, some of the light beams are absorbed by the reflector, so that light utilization efficiency is deceased.

Therefore, it is desired to provide a new kind of direct type backlight which can introduce bright and uniform light beams to illuminate an LCD panel, and thereby overcome the above-described disadvantages of the conventional direct type backlight.

### SUMMARY OF THE INVENTION

An object of the present invention is to provide a diffusion sheet which has a high light utilization efficiency and high uniformity of outgoing light.

Another object of the present invention is to provide a direct type backlight module utilizing the above-described diffusion sheet.

A diffusion sheet of the present invention comprises a light incident surface having a subwavelength grating formed thereat, and a light emitting surface opposite to the light incident surface.

When light beams propagate through the subwavelength grating, they are diffracted forward and backward to form front diffraction waves and back diffraction waves. Because the subwavelength grating is a zeroth-order grating, it only propagates the zeroth-order diffraction waves. Therefore, based on diffraction theory, the back diffraction waves can be eliminated by adjusting the period T and the shape of the subwavelength grating. If this is done, almost all the incident light beams are transmitted through the incident surface. The efficiency of light utilization is thereby enhanced.

Moreover, when the light beams propagate through the subwavelength grating, the light beams are diffracted and distributed uniformly. Accordingly, the diffusion sheet yields high uniformity of outgoing light emitted from the emitting surface.

Other objects, advantages, and novel features of the present invention will become more apparent from the following detailed description when taken in conjunction with the accompanying drawings.

### BRIEF DESCRIPTION OF THE DRAWINGS

FIG. 1 is a schematic side view of a backlight module, the backlight module comprising a diffusion sheet in accordance with a first embodiment of the present invention, a plurality of light sources, and a reflector.

FIG. 2 is an isometric view of the diffusion sheet of FIG. 1.

FIG. 3 is an isometric view of a diffusion sheet in accordance with a second embodiment of the present invention.

FIG. 4 is a side view of the diffusion sheet of FIG. 3.

FIG. 5 is a side view of the plurality of light sources of FIG. 1, and a reflector in accordance with an alternative embodiment of the present invention.

FIG. 6 is a side view of the plurality of light sources of FIG. 1, and a reflector in accordance with a further alternative embodiment of the present invention.

FIG. 7 is a schematic, cross-sectional view of a conventional backlight module.

### DETAILED DESCRIPTION OF THE INVENTION

Reference now will be made to the drawings to describe the present invention in detail.

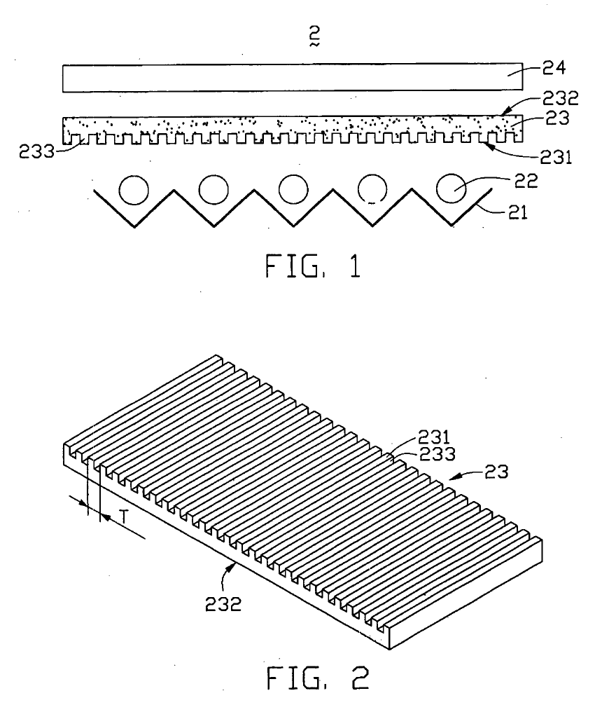

Referring to FIG. 1, a preferred backlight module 2 of the present invention comprises a reflector 21, a plurality of light sources 22, a diffusion sheet 23 as a diffusion member, and a prism sheet 24. The light sources 22 are normal, linear cold cathode fluorescent tubes (CCFLs). The reflector 21 comprises a plurality of contiguous V-shaped portions, the V-shaped portions at least partially receiving the light sources 22 respectively.

Also referring to FIG. 2, an isometric view of a first embodiment the diffusion sheet 23 is shown. The diffusion sheet 23 is made of a transparent organic resin material, such as polymethyl methacrylate (PMMA), polycarbonate (PC) or the like. The diffusion sheet 23 has a light incident surface 231 facing the light sources 22 and a light emitting surface 232. The diffusion sheet 23 includes a plurality of light scattering particles (not labeled) therein. The incident surface 231 has a subwavelength grating 233 formed thereat. The subwavelength grating 233 is integrally formed as part of the diffusion sheet 23. The subwavelength grating 233 defines a plurality of parallel channels, and each of the channels defines a rectangular cross-section.

In operation, the light sources 22 emit light beams. When the light beams propagate through the subwavelength grating 233, they are diffracted forward and backward, to form front diffraction waves and back diffraction waves. Because the subwavelength grating 233 is a zeroth-order grating, it only propagates the zeroth-order diffraction waves. Therefore, based on diffraction theory, the back diffraction waves can be eliminated by adjusting the period T and the shape of the subwavelength grating 233. If this is done, almost all the incident light beams are transmitted through the incident surface 231. Thereby, the efficiency of light utilization is enhanced.

Moreover, when the light beams propagate through the subwavelength grating 233, the light beams are diffracted and distributed uniformly. Accordingly, the diffusion sheet 23 yields high uniformity of outgoing light emitted from the emitting surface 232.

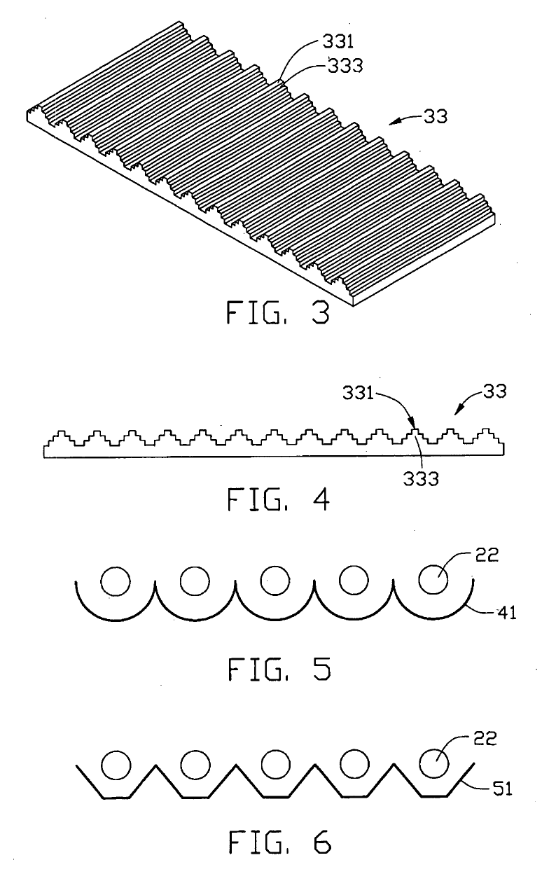

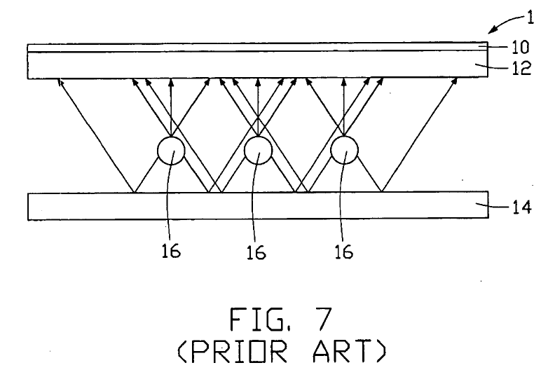

Referring to FIGS. 3 and 4, a second embodiment diffusion sheet 33 of the present invention is shown. The diffusion sheet 33 has a light incident surface 331. The diffusion sheet 33 includes a plurality of light scattering particles (not shown) therein. The incident surface 331 has a subwavelength grating 333 formed therein. The subwavelength grating 333 defines a plurality of parallel generally v-shaped or pyramid-shaped cuts.

Referring to FIG. 5, an alternative reflector 41 is shown. The reflector 41 comprises a plurality of contiguous semicylindrical portions, the semicylindrical portions at least partially receiving the light sources 22 respectively.

Referring to FIG. 6, a further alternative reflector 51 is shown. The reflector 51 comprises a plurality of contiguous polygonal-shaped portions, the polygonal-shaped portions at least partially receiving the light sources 22 respectively.

It is to be further understood that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A diffusion sheet, comprising:
a light incident surface having a subwavelength grating formed thereat;
and a light emitting surface opposite to the light incident surface.

2. The diffusion sheet as claimed in claim 1, wherein the diffusion sheet is made of polymethyl methacrylate (PMMA).

3. The diffusion sheet as claimed in claim 1, wherein the diffusion sheet is made of polycarbonate (PC).

4. The diffusion sheet as claimed in claim 1, wherein the diffusion sheet includes a plurality of light scattering particles therein.

5. The diffusion sheet as claimed in claim 1, wherein the subwavelength grating defines a plurality of parallel channels, and each of the channels defines a rectangular cross-section.

6. The diffusion sheet as claimed in claim 1, wherein the subwavelength grating defines a plurality of parallel generally v-shaped cuts.

7. A backlight module, comprising:
a plurality of light sources;
and a diffusion sheet adjacent to the light sources, the diffusion sheet comprising a light incident surface for receiving light beams from the light sources and a light emitting surface opposite to the light incident surface for emitting the light beams, the light incident surface having a continuous subwavelength grating formed thereat.

8. The backlight module as claimed in claim 7, further comprising a prism sheet adjacent to the light emitting surface.

9. The backlight module as claimed in claim 7, further comprising a reflector having a plurality of contiguous V-shaped portions, the V-shaped portions at least partially receiving the light sources respectively.

10. The backlight module as claimed in claim 7, further comprising a reflector having a plurality of contiguous semicylindrical portions, the semicylindrical portions at least partially receiving the light sources respectively.

11. The backlight module as claimed in claim 7, further comprising a reflector having a plurality of contiguous polygonal-shaped portions, the polygonal-shaped portions at least partially receiving the light sources respectively.

12. The backlight module as claimed in claim 7, wherein the diffusion sheet is made of polymethyl methacrylate (PMMA).

13. The backlight module as claimed in claim 7, wherein the diffusion sheet is made of polycarbonate (PC).

14. The backlight module as claimed in claim 7, wherein the diffusion sheet includes a plurality of light scattering particles therein.

15. The backlight module as claimed in claim 7, wherein the subwavelength grating defines a plurality of parallel channels, and each of the channels defines a rectangular cross-section.

16. The backlight module as claimed in claim 7, wherein the subwavelength grating defines a plurality of parallel generally v-shaped cuts.

17. A backlight module, comprising:
a light sources;
and a diffusion member disposed adjacent to said light sources, and comprising a light incident surface for receiving light from said light source into said diffusion member and a light emitting surface for emitting said light out of said diffusion member, a subwavelength grating formed on said light incident surface so as to diffuse said light before said light is transmitted in said diffusion member.

18. The backlight module as claimed in claim 17, wherein said subwavelength grating defines a plurality of parallel channels with a cross-section shaped as one of a rectangle and a pyramid.

19. The backlight module as claimed in claim 17, wherein said diffusion member comprises a plurality of light scattering particles installed therein.

20. The backlight module as claimed in claim 17, wherein said subwavelength grating of said diffusion member is disposed to directly face said light source.
